(19) United States
(12) Patent Application Publication
(10) Pub. No.: US 2026/0010003 A1
(43) Pub. Date: Jan. 8, 2026

(54) LIGHT GUIDE PLATE AND DISPLAY APPARATUS

(71) Applicant: HannStar Display Corporation, Taipei City (TW)

(72) Inventors: Yu-Chi Chiao, Taipei City (TW); Chen-Hao Su, Taipei City (TW); Cheng-Yen Yeh, Taipei City (TW); Chun-Ming Hsu, Taipei City (TW); Yen-Chung Chen, Taipei City (TW); Chin-Hui Chen, Taipei City (TW)

(73) Assignee: HannStar Display Corporation, Taipei City (TW)

(21) Appl. No.: 18/957,853

(22) Filed: Nov. 24, 2024

(30) Foreign Application Priority Data
Jul. 8, 2024 (TW) 113125437

(51) Int. Cl. G02B 27/01

(52) U.S. Cl. CPC G02B 27/0101; G02B 2027/0118

(57) ABSTRACT

A light guide plate of a display apparatus including a first surface, a second surface and a plurality of optical microstructures is provided. The first surface and the second surface are arranged facing away from each other. The optical microstructures are protruded from the second surface, and each has a first optical surface and a second optical surface. A first included angle between the first optical surface and a virtual extension plane of the second surface is greater than or equal to 45 degrees and less than or equal to 90 degrees. A second included angle between the second optical surface and the virtual extension plane is greater than or equal to 30 degrees and less than or equal to 54 degrees. External light from one side of the second surface of the light guide plate is adapted to be transmitted to the first surface via the optical microstructures.

### CROSS-REFERENCE TO RELATED APPLICATION

This application claims the priority benefit of Taiwan application serial no. 113125437, filed on Jul. 8, 2024. The entirety of the above-mentioned patent application is hereby incorporated by reference herein and made a part of this specification.

### BACKGROUND

### Technical Field

The disclosure relates to a light guide plate and a display apparatus, and more particularly, to a light guide plate and display apparatus provided with optical microstructures.

### Description of Related Art

The advent of monitor light bars meets the operational needs of a display apparatus when indoor lighting is insufficient. The monitor light bar is suitable for installation on a computer monitor or a laptop screen, and illuminates the screen and the desk area around the screen at a specific angle. However, for reflective displays, the light distribution of such kind of light source is difficult to meet the users' requirements for display brightness and uniformity of visual effect at viewing angles.

### SUMMARY

The disclosure provides a light guide plate that can increase the utilization rate of light energy of external light.

The disclosure provides a display apparatus with improved uniformity of visual effect of light output.

A light guide plate in the disclosure includes a first surface, a second surface and a plurality of optical microstructures. The first surface and the second surface are arranged facing away from each other. The optical microstructures are protruded from the second surface, and each has a first optical surface and a second optical surface. A first included angle between the first optical surface and a virtual extension plane of the second surface is greater than or equal to 45 degrees and less than or equal to 90 degrees. A second included angle between the second optical surface and the virtual extension plane is greater than or equal to 30 degrees and less than or equal to 54 degrees. External light from one side of the second surface of the light guide plate is adapted to be transmitted to the first surface via the optical microstructures.

A display apparatus in the disclosure includes a display panel and a light guide plate. A display panel has a display surface. A light guide plate is disposed on one side of the display surface of the display panel. The light guide plate includes a first surface, a second surface and a plurality of optical microstructures. The first surface and the second surface are arranged facing away from each other. The optical microstructures are protruded from the second surface, and each has a first optical surface and a second optical surface. A first included angle between the first optical surface and a virtual extension plane of the second surface is greater than or equal to 45 degrees and less than or equal to 90 degrees. A second included angle between the second optical surface and the virtual extension plane is greater than or equal to 30 degrees and less than or equal to 54 degrees. External light from one side of the second surface of the light guide plate is adapted to be transmitted to the first surface via the optical microstructures.

Based on the above, in a display apparatus according to an embodiment of the disclosure, a light guide plate is provided on one side of the display surface of the display panel, and a plurality of optical microstructures are provided on a surface of one side of the light guide plate facing away from the display panel. The optical microstructures are adapted to deflect external light from the side of the light guide plate to the display surface of the display panel. Accordingly, the utilization rate of light energy of the external light may be effectively increased, and the uniformity of visual effect of light output of the display apparatus can be improved.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic front view of a display apparatus according to a first embodiment of the disclosure.

FIG. 2 is a schematic cross-sectional view of the display apparatus of FIG. 1.

FIG. 3 is a schematic cross-sectional view of a display apparatus according to a second embodiment of the disclosure.

FIG. 4 is a schematic cross-sectional view of a display apparatus according to a third embodiment of the disclosure.

FIG. 5 is a schematic cross-sectional view of a display apparatus according to a fourth embodiment of the disclosure.

FIG. 6 is a schematic cross-sectional view of a display apparatus according to a fifth embodiment of the disclosure.

FIG. 7 is a schematic cross-sectional view of a display apparatus according to a sixth embodiment of the disclosure.

FIG. 8 is a schematic cross-sectional view of a display apparatus according to a seventh embodiment of the disclosure.

### DESCRIPTION OF THE EMBODIMENTS

The aforementioned and other technical contents, features, and effects of the disclosure will be clearly presented in the following detailed description of a preferred embodiment with reference to the accompanying drawings. The directional terms mentioned in the following embodiments, such as up, down, left, right, front, or back, are merely references to the directions in the accompanying drawings. Therefore, the directional terms used are for explanatory purposes and are not intended to limit the present invention.

Exemplary embodiments of the disclosure are now described in detail with reference to the accompanying drawings. Wherever possible, the same reference numerals are used in the drawings and the description to refer to the same or similar parts.

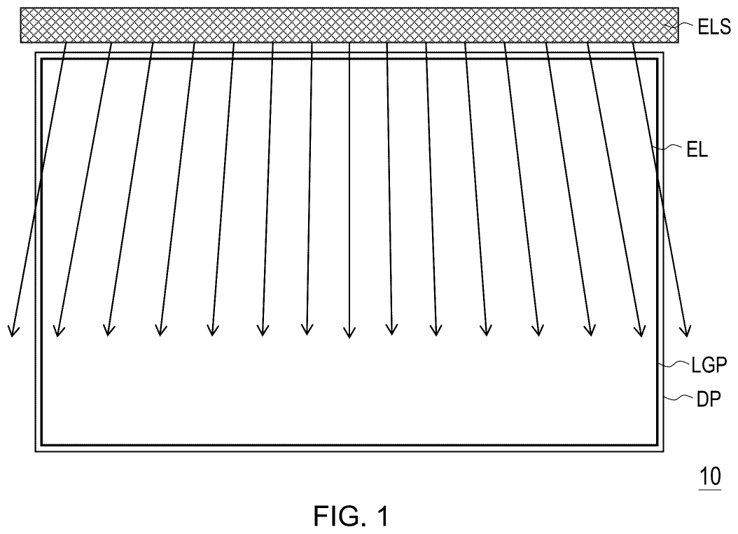

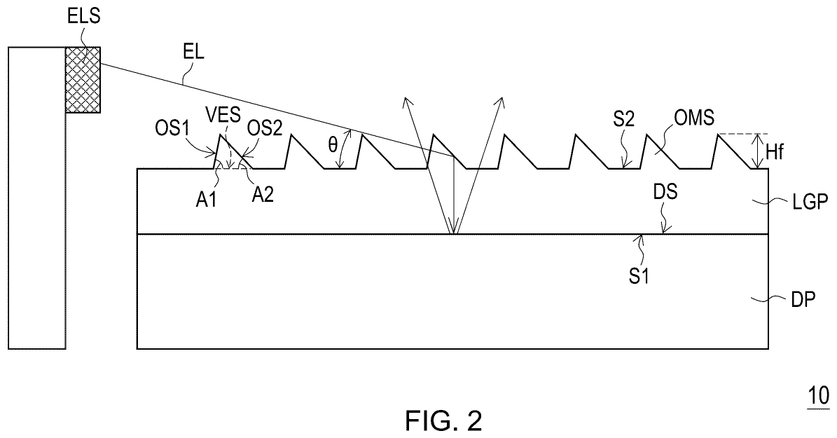

FIG. 1 is a schematic front view of a display apparatus according to a first embodiment of the disclosure. FIG. 2 is a schematic cross-sectional view of the display apparatus of FIG. 1. Referring to FIG. 1 and FIG. 2, a display apparatus 10 includes a display panel DP and a light guide plate LGP. The light guide plate LGP is disposed on one side of a display surface DS of the display panel DP, and overlaps the display surface DS in a normal direction of the display surface DS. In the embodiment, the display panel DP is, for example, a reflective display panel that reflects the light transmitted to the display panel DP via the light guide plate LGP to display a corresponding image. For example, the display panel DP may be a reflective display panel or a transflective display panel.

The light guide plate LGP has a first surface S1 and a second surface S2 facing away from each other, wherein the first surface S1 faces the display surface DS of the display panel DP. A plurality of optical microstructures OMS are provided on the second surface S2 of the light guide plate LGP, and the optical microstructures OMS protrude from the second surface S2. It should be noted first that the optical microstructures OMS are suitable for deflecting light (for example, external light EL in FIG. 2) from one side of the second surface S2 of the light guide plate LGP to the display surface DS of the display panel DP. More specifically, light from the side of the second surface S2 of the light guide plate LGP can be transmitted to the first surface S1 of the light guide plate LGP via the optical microstructure OMS, and then transmitted to the display surface DS of the display panel DP. The display panel DP can reflect the light transmitted to the display surface DS of the display panel DP to display a corresponding image. For example, each pixel of the display panel DP may include a reflective plate (e.g., a silver reflective layer or an aluminum reflective layer, but the disclosure is not limited thereto), and the reflective plate may reflect the light transmitted to the display surface DS of the display panel DP.

For example, in the embodiment, the display apparatus 10 may optionally include an external light source ELS. The external light source ELS is detachably arranged on one side of the display panel DP and is used to emit external light EL. The external light source ELS is, for example, a screen light bar, but the disclosure is not limited thereto. For example, when the user wants to use the display apparatus in a low-light environment, the external light source ELS can be mounted and secured to one side of the display panel DP to improve the visibility of the image displayed on the display panel DP. When the user has finished using the display apparatus or when the user uses the display apparatus in a well-lit environment, the external light source ELS can be detached from the display panel DP. In addition, when the external light source ELS is mounted and secured to one side of the display panel DP, the user can also adjust an incident angle (i.e., an angle between an incident direction of the external light EL of the external light source ELS and the second surface S2 of the light guide plate LGP) of the external light EL of the external light source ELS to obtain the best visual effect. Therefore, the external light source ELS of the embodiment may meet the needs for portability and for the user to adjust the incident angle of light. It is particularly important to note that the external light EL from the external light source ELS is incident on the light guide plate LGP in a manner that is closer to the second surface S2. For example, an angle θ between the incident direction of the external light EL and the second surface S2 of the light guide plate LGP may be greater than 0 degrees and less than or equal to 5 degrees, but the disclosure is not limited thereto. More specifically, the external light EL emitted by the external light source ELS of the embodiment is incident on the second surface S2 of the light guide plate LGP at multiple angles ranging from 0 degrees to 5 degrees.

Since the incident angle of the external light EL from one side (for example, the upper side in FIG. 1) of the display panel DP is small, if the second surface S2 of the light guide plate LGP is a planar surface and without the optical microstructures OMS, part of the external light EL is easily reflected by the second surface S2 and cannot be directed toward the display surface DS of the display panel DP. Therefore, through the arrangement of the plurality of optical microstructures OMS mentioned above, the external light EL can be effectively directed toward the display surface DS of the display panel DP, thereby improving the utilization rate of light energy of the display apparatus 10.

Furthermore, each of the optical microstructures OMS has a first optical surface OS1 and a second optical surface OS2. The first optical surface OS1 is closer to the external light source ELS compared to the second optical surface OS2 (i.e., the first optical surface OS1 faces the external light source ELS and the second optical surface OS2 faces away from the external light source ELS). In the embodiment, both the first optical surface OS1 and the second optical surface OS2 may be a planar surface, but the disclosure is not limited thereto. A first included angle A1 between the first optical surface OS1 and a virtual extension plane VES of the second surface S2 is greater than or equal to 45 degrees and less than or equal to 90 degrees. Preferably, the first included angle A1 may be greater than or equal to 70 degrees and less than or equal to 90 degrees. A second included angle A2 between the second optical surface OS2 and the virtual extension plane VES of the second surface S2 is greater than or equal to 30 degrees and less than or equal to 54 degrees. Furthermore, in the embodiment, a refractive index of the light guide plate LGP may be greater than or equal to 1.5 and less than or equal to 1.7. Preferably, the refractive index of the light plate LGP may be 1.6.

Through the above-mentioned design of the first included angle A1 and the second included angle A2, the external light EL from one side of the second surface S2 of the light guide plate LGP can pass through the first optical surface OS1 of the optical microstructure OMS, and be reflected (e.g., via total internal reflection) by the second optical surface OS2 to be transmitted to the display surface DS to serve as the illumination light required for the display panel DP during operation.

In the embodiment, a height Hf of the optical microstructure OMS along a normal direction of the second surface S2 is less than 100 microns. Preferably, the height Hf of the optical microstructure OMS may be greater than or equal to 5 microns and less than or equal to 20 microns. In particular, when the height Hf of the optical microstructure OMS is less than 20 microns, the visibility of the optical microstructure OMS may be effectively reduced to improve the quality of the image viewed by the user.

In the embodiment, each optical microstructure OMS has substantially the same height Hf. In order to effectively deflect light at a specific incident angle, preferably, the first included angle A1 of the first optical surface OS1 may be greater than or equal to 85 degrees and less than or equal to 90 degrees, and the second included angle A2 of the second optical surface OS2 may be greater than or equal to 45 degrees and less than or equal to 50 degrees.

In particular, the first included angle A1 and the second included angle A2 of each optical microstructure OMS may be designed based on the incident light intensity at its location. In addition to increasing the utilization rate of light energy of the external light EL, the uniformity of visual effect of light output of the display apparatus 10 can also be improved.

Other embodiments will be enumerated below to describe the present disclosure in detail, in which the same components will be denoted by the same symbols, and descriptions of the same technical content will be omitted. Please refer to the previous embodiments for the omitted parts, which will not be described again below.

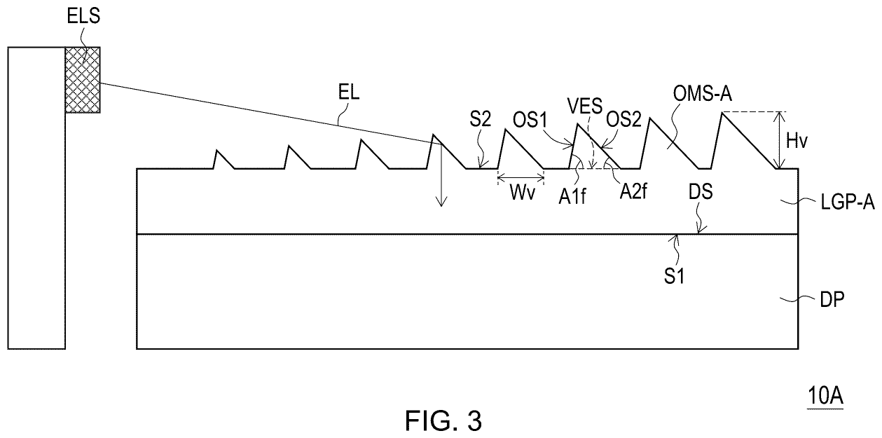

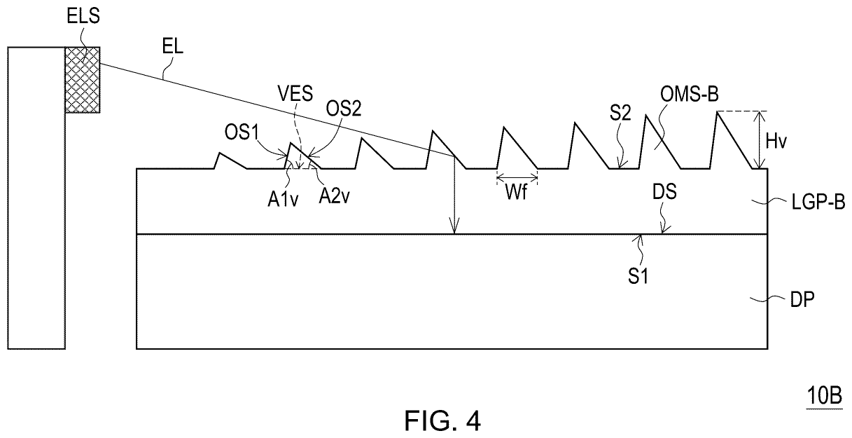

FIG. 3 is a schematic cross-sectional view of a display apparatus according to a second embodiment of the disclosure. FIG. 4 is a schematic cross-sectional view of a display apparatus according to a third embodiment of the disclosure. Referring to FIG. 3, the difference between a display apparatus 10A of the embodiment and the display apparatus 10 of FIG. 2 is that the design of the optical microstructure is different. Specifically, in the display apparatus 10A of the embodiment, the plurality of optical microstructures OMS-A of the light guide plate LGP-A may have multiple sizes. In the embodiment, heights Hv of the plurality of the optical microstructures OMS-A increase gradually along a direction away from the external light source ELS. For example, the heights Hv of the plurality of optical microstructures OMS-A may increase sequentially along the direction away from the external light source ELS, and the height Hv of each optical microstructures OMS-A may be in a range greater than or equal to 5 microns and less than or equal to 20 microns. Accordingly, the light guide plate LGP-A can effectively deflect light at various incident angles.

In the embodiment, the first included angle A1f of each optical microstructure OMS-A is substantially the same, and the second included angle A2f of each optical microstructure OMS-A is substantially the same. That is, each optical microstructure OMS-A has a width Wv along an arrangement direction of the first optical surface OS1 and the second optical surface OS2, and the widths Wv of the plurality of the optical microstructures OMS-A increase sequentially and gradually along the direction away from the external light source ELS.

However, the disclosure is not limited thereto. Referring to FIG. 4, in a display apparatus 10B of another embodiment, the width Wf of each optical microstructure OMS-B on the light guide plate LGP-B may be substantially the same. Since the heights Hv of the plurality of the optical microstructures OMS-B increase along the direction away from the external light source ELS, both the first included angles Alv and the second included angles A2v of the plurality of the optical microstructures OMS-B increase sequentially and gradually along the direction away from the external light source ELS.

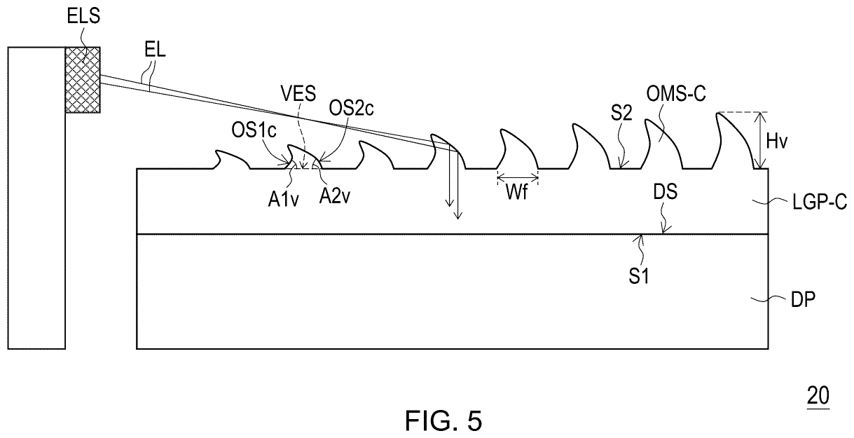

FIG. 5 is a schematic cross-sectional view of a display apparatus according to a fourth embodiment of the disclosure. Referring to FIG. 5, the difference between a display apparatus 20 of the embodiment and the display apparatus 10B of FIG. 4 is that the configuration of the optical microstructure is different. In the embodiment, both the first optical surface OS1c and the second optical surface OS2c of the optical microstructure OMS-C of the light guide plate LGP-C may be curved surfaces. More specifically, these optical surfaces are all curved surfaces that are concave toward the external light source ELS (i.e., both the first optical surface OS1c and the second optical surface OS2c are concave in a direction away from the external light source ELS). Through the design of the curved surface, the optical microstructure OMS-C can effectively deflect light at various incident angles and enhance the light concentration after deflection.

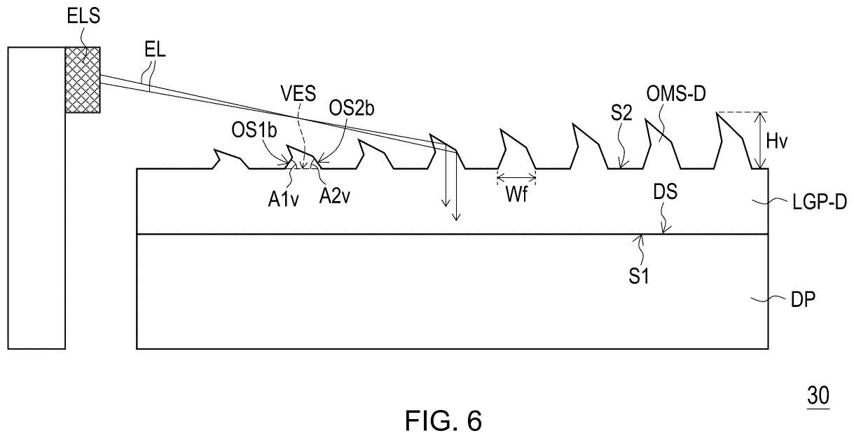

FIG. 6 is a schematic cross-sectional view of a display apparatus according to a fifth embodiment of the disclosure. Referring to FIG. 6, the difference between a display apparatus 30 of the embodiment and the display apparatus 10B of FIG. 4 is that the configuration of the optical microstructures is different. In the embodiment, both the first optical surface OS1b and the second optical surface OS2b of the optical microstructure OMS-D of the light guide plate LGP-D may be folded surfaces. More specifically, these optical surfaces are all folded surfaces that are concave toward the external light source ELS (i.e., both the first optical surface OS1b and the second optical surface OS2b are concave in a direction away from the external light source ELS). That is, both the first optical surface OS1b and the second optical surface OS2b may be composed of a plurality of planes. For example, both the first optical surface OS1b and the second optical surface OS2b may be composed of a plurality of inclined planes having different angles of inclination. Through the design of the folded surface, the optical microstructure OMS-D can effectively deflect light at various incident angles and enhance the light concentration after deflection.

In the embodiment, the number of planes constituting each optical surface is exemplified by taking two as an example. However, in other embodiments, the number of planes constituting each optical surface may be adjusted according to different optical requirements. For example, the number of planes constituting the first optical surface may be different from the number of planes constituting the second optical surface, or the number of planes constituting the first optical surface or the second optical surface of the optical microstructures at different positions may be different.

In the embodiments of FIG. 5 and FIG. 6, through the design of curved surfaces or folded surfaces, the optical microstructures OMS-C and OMS-D can effectively deflect light at various incident angles. For example, in the embodiments of FIG. 5 and FIG. 6, an angle between an incident direction of the external light EL and the second surface S2 of the light guide plate LGP-C or the light guide plate LGP-D may be greater than 0 degrees and less than or equal to 45 degrees (i.e., the external light EL emitted by the external light source ELS is incident on the second surface S2 of the light guide plate LGP-C or the light guide plate LGP-D at multiple angles ranging from 0 degrees to 45 degrees), and the optical microstructure OMS-C with curved surfaces or the optical microstructure OMS-D with folded surfaces may effectively deflect external light EL within this range of angles.

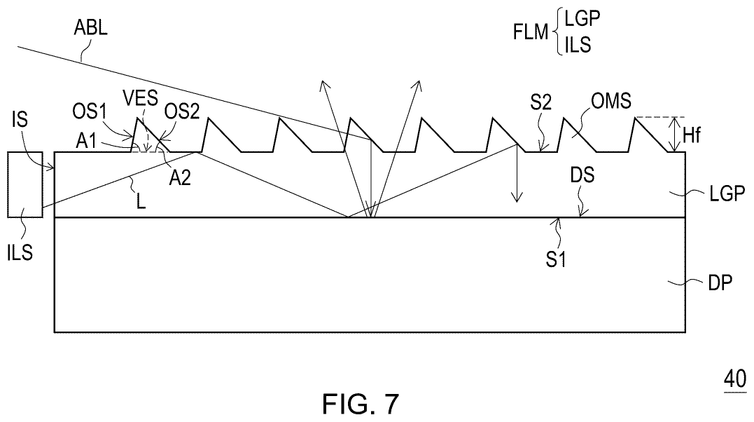

FIG. 7 is a schematic cross-sectional view of a display apparatus according to a sixth embodiment of the disclosure. Referring to FIG. 7, the main difference between a display apparatus 40 and the display apparatus 10 of FIG. 2 is that the display apparatus 40 is not provided with the external light source ELS as shown in FIG. 2. Nonetheless, the plurality of optical microstructures OMS on the light guide plate LGP are still suitable for deflecting ambient light ABL with a specific incident angle range to the display surface DS of the display panel DP.

Since the operational principle of the optical microstructure OMS of the embodiment for the ambient light ABL is similar to the operational principle of the optical microstructure OMS for the external light EL from the external light source ELS in FIG. 2, please refer to the relevant paragraphs of the foregoing embodiment for detailed description, which will not be described again below.

It is particularly noted that in the embodiment, the display apparatus 40 may optionally include a built-in light source ILS. More specifically, the display apparatus 40 includes a front light module FLM, and the front light module FLM includes a light guide plate LGP and a built-in light source ILS. For example, the light guide plate LGP also has a light incident surface IS connecting the first surface S1 and the second surface S2, and the built-in light source ILS is disposed on one side of the light incident surface IS of the light guide plate LGP. The built-in light source ILS is composed of, for example, at least one light bar or at least one light plate, but the disclosure is not limited thereto. The difference between the built-in light source ILS of the embodiment and the external light source ELS of the aforementioned embodiment is described below. The external light source ELS is detachably arranged on one side of the display panel DP, and the user can decide to mount and secure the externa light source ELS to one side of the display panel DP or detach the external light source ELS from the display panel DP based on the needs and/or the ambient brightness. However, the built-in light source ILS of the embodiment is fixed in the display apparatus 40 (i.e., fixed in the front light module FLM of the display apparatus 40), and the user cannot detach the built-in light source ILS at will. In addition, as mentioned previously, the user can adjust the incident angle of the external light EL of the external light source ELS according to the needs. However, since the built-in light source ILS is built in the front light module FLM of the display apparatus 40, the user cannot adjust the incident angle of the light from the built-in light source ILS at will.

In the embodiment, the optical microstructure OMS is also suitable for guiding the light L from the built-in light source ILS and transmitted in the light guide plate LGP via reflections (e.g., total internal reflection) of the first surface S1 and the second surface S2 to the display surface DS of the display panel DP. For example, when the ambient light ABL is insufficient, the built-in light source ILS may be turned on to supplement the amount of illumination required for the display panel DP during operation. On the contrary, when the ambient light ABL is sufficient, the built-in light source ILS may be turned off to save power consumption.

It should be understood that in other modified implementations of the embodiment, the optical surface configuration of the optical microstructure may also be the optical surface configuration disclosed in the foregoing embodiments, such as a folded surface, a curved surface, or a combination of the above. On the other hand, the plurality of optical microstructures OMS of the embodiment may also be replaced by the plurality of optical microstructures OMS-A of FIG. 3, the plurality of optical microstructures OMS-B of FIG. 4, the plurality of optical microstructures OMS-C of FIG. 5, or the plurality of optical microstructures OMS-D of FIG. 6.

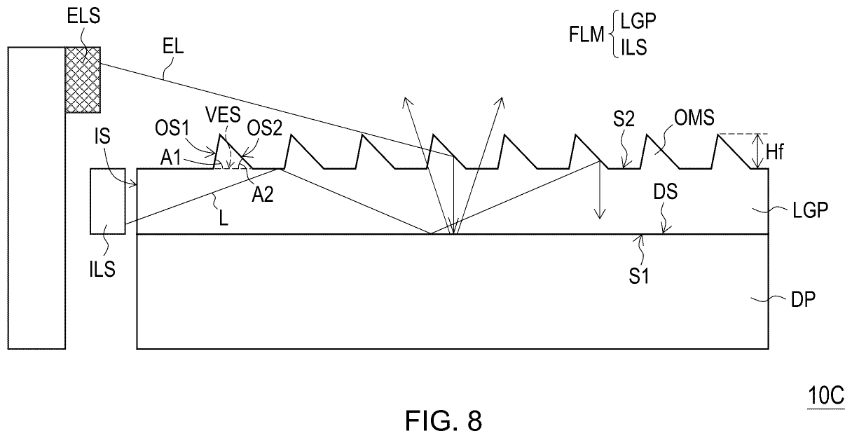

FIG. 8 is a schematic cross-sectional view of a display apparatus according to a seventh embodiment of the disclosure. Referring to FIG. 8, the main difference between a display apparatus 10C of the embodiment and the display apparatus 10 of FIG. 2 is that the display apparatus 10C may optionally be provided with a built-in light source ILS. For example, the light guide plate LGP also has a light incident surface IS connecting the first surface S1 and the second surface S2, and the built-in light source ILS is disposed on one side of the light incident surface IS of the light guide plate LGP. The built-in light source ILS is composed of, for example, at least one light bar or at least one light plate, but the disclosure is not limited thereto.

In the embodiment, the optical microstructure OMS is also suitable for guiding the light L from the built-in light source ILS and transmitted in the light guide plate LGP via reflections of the first surface S1 and the second surface S2 to the display surface DS of the display panel DP.

For example, in order to achieve better display quality, the external light source ELS and the built-in light source ILS can be turned on at the same time. To save power consumption or meet different display requirements, only the external light source ELS or the built-in light source ILS may be turned on.

It should be understood that in other modified implementations of the embodiment, the optical surface configuration of the optical microstructure may also be the optical surface configuration disclosed in the foregoing embodiments, such as a folded surface, a curved surface, or a combination of the above. On the other hand, the plurality of optical microstructures OMS of the embodiment may also be replaced by the plurality of optical microstructures OMS-A of FIG. 3, the plurality of optical microstructures OMS-B of FIG. 4, the plurality of optical microstructures OMS-C of FIG. 5, or the plurality of optical microstructures OMS-D of FIG. 6.

To sum up, in a display apparatus according to an embodiment of the disclosure, a light guide plate is provided on one side of the display surface of the display panel, and a plurality of optical microstructures are provided on a surface of one side of the light guide plate facing away from the display panel. The optical microstructures are adapted to deflect external light from the side of the light guide plate to the display surface of the display panel. Accordingly, the utilization rate of light energy of the external light may be effectively increased, and the uniformity of visual effect of light output of the display apparatus can be improved.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A light guide plate, comprising:
a first surface and a second surface, arranged facing away from each other; and
a plurality of optical microstructures, protruded from the second surface, and each having a first optical surface and a second optical surface, wherein a first included angle between the first optical surface and a virtual extension plane of the second surface is greater than or equal to 45 degrees and less than or equal to 90 degrees, a second included angle between the second optical surface and the virtual extension plane is greater than or equal to 30 degrees and less than or equal to 54 degrees, and external light from one side of the second surface of the light guide plate is adapted to be transmitted to the first surface via the optical microstructures.

2. The light guide plate according to claim 1, wherein a height of each of the optical microstructures along a normal direction of the second surface is greater than or equal to 5 microns and less than or equal to 20 microns.

3. The light guide plate according to claim 1, wherein a height of each of the optical microstructures along a normal direction of the second surface is the same, the first included angle is greater than or equal to 85 degrees, and the second included angle is greater than or equal to 45 degrees and less than or equal to 50 degrees.

4. The light guide plate according to claim 1, wherein the external light includes light from an external light source or ambient light.

5. The light guide plate according to claim 4, wherein each of the optical microstructures has a height along a normal direction of the second surface, and the heights of the optical microstructures increases sequentially along a direction away from the external light source.

6. The light guide plate according to claim 5, wherein the first included angle of each of the optical microstructures is the same, and the second included angle of each of the optical microstructures is the same.

7. The light guide plate according to claim 5, wherein the first included angles of the optical microstructures increase sequentially along the direction away from the external light source, and the second included angles of the optical microstructures increase sequentially along the direction away from the external light source.

8. The light guide plate according to claim 1, wherein each of the first optical surface and the second optical surface is at least one planar surface, at least one curved surface, or a combination of the above.

9. A display apparatus, comprising:
a display panel, having a display surface; and
a light guide plate, disposed on one side of the display surface of the display panel, and comprising:
a first surface, arranged facing the display surface;
a second surface, facing away from the first surface; and
a plurality of optical microstructures, protruded from the second surface, and each having a first optical surface and a second optical surface, wherein a first included angle between the first optical surface and a virtual extension plane of the second surface is greater than or equal to 45 degrees and less than or equal to 90 degrees, a second included angle between the second optical surface and the virtual extension plane is greater than or equal to 30 degrees and less than or equal to 54 degrees, and external light from one side of the second surface of the light guide plate is adapted to be transmitted to the first surface via the optical microstructures.

10. The display apparatus according to claim 9, further comprising:
an external light source, detachably arranged on one side of the display panel, and used to emit the external light.

11. The display apparatus according to claim 10, wherein each of the optical microstructures has a height along a normal direction of the second surface, and the heights of the optical microstructures increase sequentially along a direction away from the external light source.

12. The display apparatus according to claim 9, wherein each of the first optical surface and the second optical surface is at least one planar surface, at least one curved surface, or a combination of the above.

13. The display apparatus according to claim 9, further comprising:
a built-in light source, disposed on one side of a light incident surface of the light guide plate, wherein the light incident surface connects the first surface and the second surface.
